(19) United States
(12) Patent Application Publication
(10) Pub. No.: US 2007/0080953 A1
(43) Pub. Date: Apr. 12, 2007

(54) Method for window movement control on a touchpad having a touch-sense defined speed

(76) Inventor: Jia-Yih Lii, Taichung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/528,508

(22) Filed: Sep. 28, 2006

(30) Foreign Application Priority Data
Oct. 7, 2005 (TW) 094135247

(51) Int. Cl. G09G 5/00

(52) U.S. Cl. 345/173

(57) ABSTRACT

In a method for window movement control on a touchpad, the area size of the object sliding on the touchpad is calculated to determine the speed that the touchpad produces a movement signal to control a window such that the greater the area size is, the faster the window scrolls.

### FIELD OF THE INVENTION

The present invention is related generally to a touchpad control method and, more particularly, to a window movement control by use of a touchpad.

### BACKGROUND OF THE INVENTION

Due to the compactness, low cost, low power consumption and long lifetime, touchpad has been widely used in various electronic products such as notebook computer, mouse, MP3 player, and mobile phone, etc., as an input device. For operating with a touchpad, user needs only to use his finger or conductor such as touch pen to touch or slide on a panel of the touchpad to move a cursor on a window in a relative displacement or an absolute coordinate variation, in order to perform various functions such as text writing and window scrolling. For the applications of window movement control, by using an object to slide on a touchpad, the touchpad will generate a constant movement signal to control a window to scroll at a constant speed. The operation is inconvenient because it must spend more time when scrolling a window to a longer distance. For improving the operation's convenience, there is proposed a method for controlling the window to scroll at different speeds according to the pressure of the object pressing on a touchpad. Referring to FIGS. 1 and 2 for example, when an object 120 slides from the left to the right on a touchpad 110 to scroll a window 130, the greater the pressure of the object 120 presses, the faster the window 130 scrolls. This method of using pressure to determine the scrolling speed can save the operational time, but it may easily cause unexpected action because the object 120 presses too much, and requires greater strength for operation, so it is still inconvenient.

Therefore, it is desired a method for window movement control on a touchpad more convenient to the user's operation.

### SUMMARY OF THE INVENTION

An object of the present invention is to provide a method for scrolling a window at a speed according to the area size of an object on a touchpad.

In a method for scrolling a window at a speed, according to the present invention, the coordinate value of an object on a touchpad is calculated to produce a position information and the area size of the object on the touchpad is calculated to produce a speed information when the object is detected to slide on the touchpad, and then a movement signal is produced according to the position information and the speed information to scroll the window.

By detecting the area size of an object on a touchpad to determine the scrolling speed of a window, it is avoided easy to produce error operation and strength-consuming resulted from the pressure detection in the conventional method, and users can operate with a touchpad more conveniently and less strength.

### BRIEF DESCRIPTION OF DRAWINGS

These and other objects, features and advantages of the present invention will become apparent to those skilled in the art upon consideration of the following description of the preferred embodiments of the present invention taken in conjunction with the accompanying drawings, in which:

FIGS. 1 and 2 show a conventional method which uses the pressing pressure of an object on a touchpad to determine the scrolling speed of a window;

FIG. 3 shows a flowchart of an embodiment according to the present invention; and

FIGS. 4 and 5 show the operations of an object on a touchpad according to the method of FIG. 3.

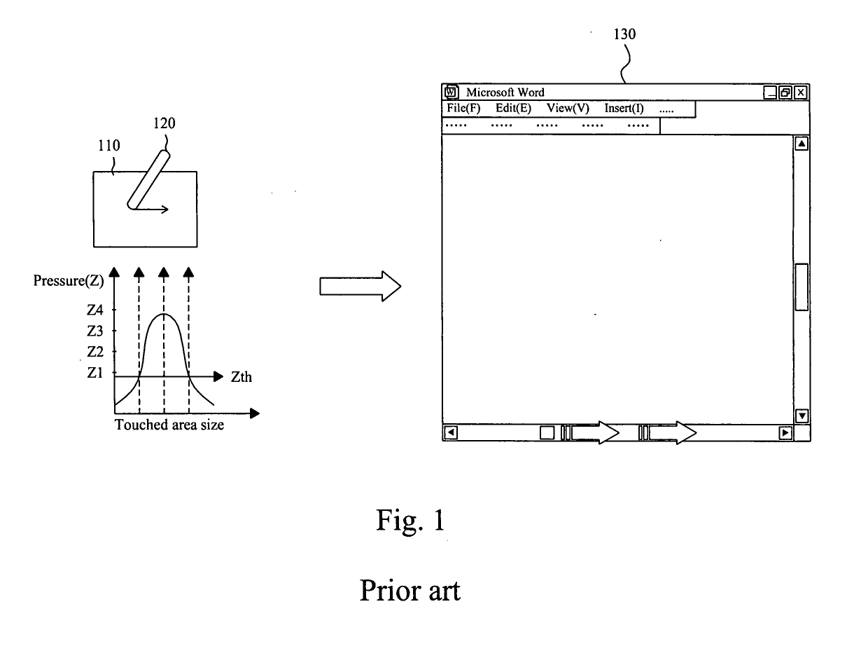

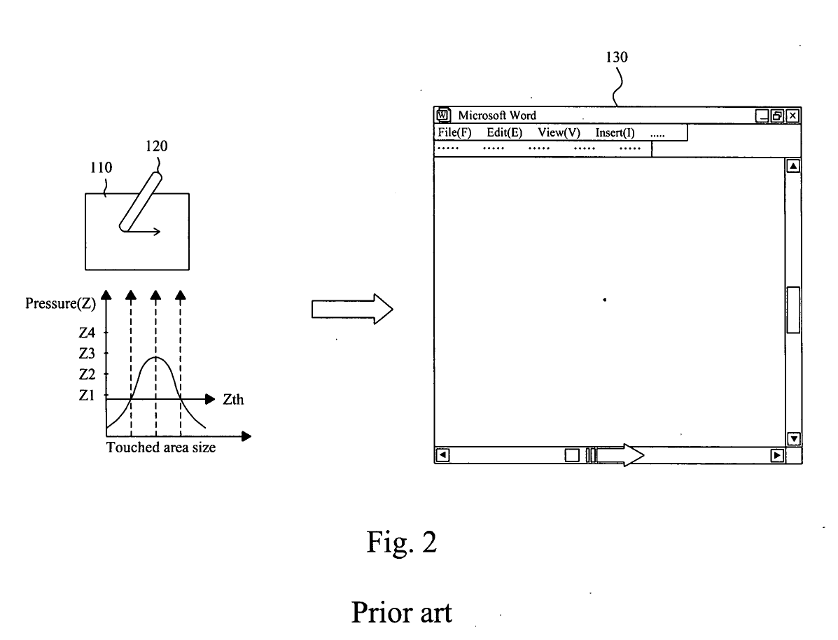

### DETAILED DESCRIPTION OF THE INVENTION

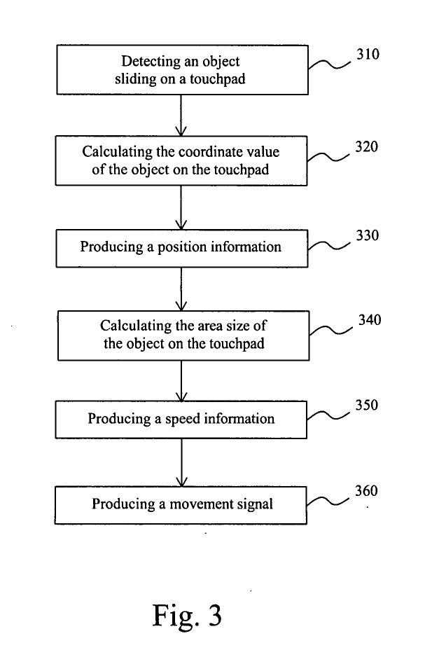

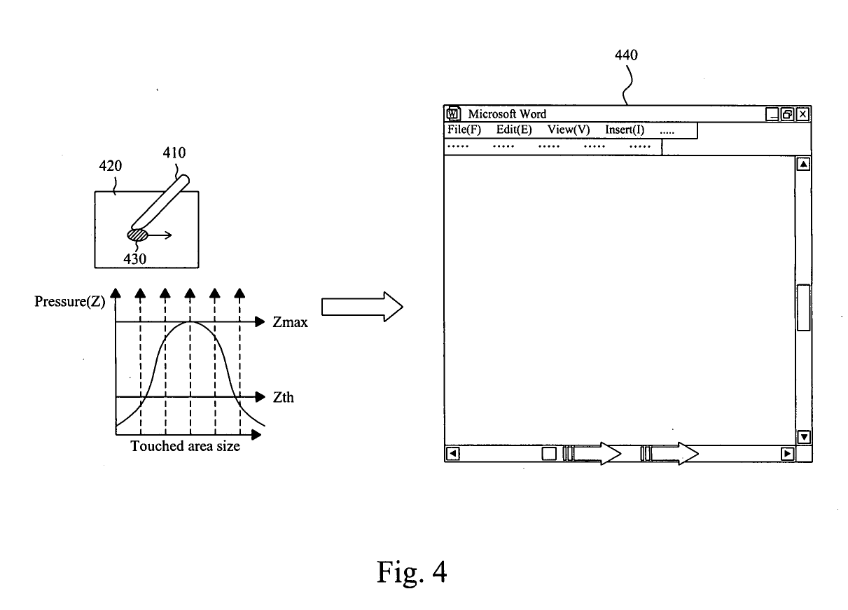

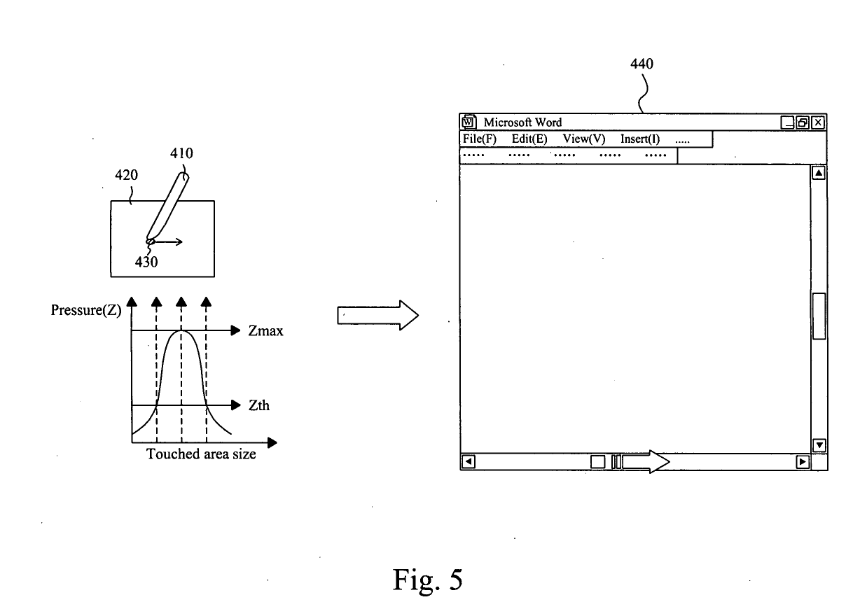

FIG. 3 shows a flowchart of an embodiment according to the present invention, and FIGS. 4 and 5 show the operations of an object on a touchpad according to the method. Referring to FIGS. 3 to 5, step 310 detects the object 410 (e.g., finger or conductive object such as touch control pen) sliding on the touchpad 420, and the pressure (Z) pressing on the touchpad 420 is detected greater than a threshold (Zth). Step 320 calculates the coordinate value of the object 410 on the touchpad 420, which includes an absolute or relative coordinate value. An absolute coordinate value refers to one produced based on a fixed position (e.g., the center or a corner of the touchpad 420) as the original point of a coordinate system, and a relative coordinate value refers to one produced based on a relative position (e.g., the position where the object 410 first touches on the touchpad 420) as the original point of a coordinate system. Step 330 produces a position information according to the coordinate value calculated at step 320, which includes the sliding direction of the object 410 on the touchpad 420. Step 340 calculates the area size 430 of the object 410 on the touchpad 420, and step 350 produces a speed information according to the area size 430 calculated at step 340. For example, the greater the area size 430 is, the faster the speed is. Step 360 produces a movement signal according to the position information produced at step 330 and the speed information produced at step 350, to scroll the window 440. For example, when the object 410 is detected sliding from the left to the right on the touchpad 420 with a greater area size 430, as shown in FIG. 4, the window 440 will scroll towards right at a higher speed, so it can quickly move to the target position. As shown in FIG. 5, when the object 410 is detected sliding from the left to the right on the touchpad 420 with a less area size 430, the window 440 will scroll towards right at a lower speed, so it can accurately move to the target position. In the embodiment shown in FIGS. 4 and 5, the pressures (Zmax) brought by the object 410 on the touchpad 420 are the same.

In different operations, the moving direction of the object 410 may be upward, downward, leftward, or rightward, and together with the area size 430 of the object 410 on the touchpad 420, it can control the window 440 to move to the target position quickly and accurately, thereby increasing the convenience in operation.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as set fourth in the appended claims.

What is claimed is:

1. A method for window movement control on a touchpad having a touch-sense defined speed, the method comprising the steps of:
detecting an object sliding on the touchpad;
calculating a coordinate value of the object on the touchpad;
producing a position information according to the coordinate value;
calculating an area size of the object on the touchpad;
producing a speed information according to the area size; and
producing a movement signal according to the position information and the speed information to scroll a window.

2. The method of claim 1 wherein the coordinate value comprises an absolute coordinate value or a relative coordinate value.

3. The method of claim 1, wherein the position information comprises a sliding direction of the object on the touchpad.

4. The method of claim 1, wherein the step of producing a speed information according to the area size comprises the step of determining the speed such that the greater the area size is, the higher the speed is.
